(19) United States
(12) Patent Application Publication
(10) Pub. No.: US 2024/0346676 A1
(43) Pub. Date: Oct. 17, 2024

(54) DIGITAL MEASUREMENT SYSTEMS

(71) Applicant: Inversion Solutions LLC, Charlotte, NC (US)

(72) Inventor: Zack Raboin, Charlotte, NC (US)

(21) Appl. No.: 18/300,553

(22) Filed: Apr. 14, 2023

(51) Int. Cl. G06T 7/60; G06T 7/70; G06T 17/00; G06T 19/00; G06V 20/40; G06V 20/62; H04N 5/265; H04N 23/63

(52) U.S. Cl. CPC G06T 7/60; G06T 7/70; G06T 17/00; G06T 19/006; G06V 20/40; G06V 20/63; H04N 5/265; H04N 23/63; G06T 2207/30184; G06T 2207/30244

(57) ABSTRACT

The disclosed systems and methods can capture a video feed of a first object. The first object can be a type of infrastructure, including but not limited to, utility poles, signs, streetlights, bridges, tunnels, pipes, or any other type of structure. The first object in the video feed can be identified. A plane associated with the first object can be determined. A second object, such as a pixel design representing a dimension measurement, can be placed on the plane parallel to and adjacent to the first object. The second object can be rendered in the video feed. The second object can be used to determine sizing metadata. The sizing metadata can be used to calculate a measurement, such as height, length, width, or depth, associated with the first object.

### TECHNICAL FIELD

The present systems and processes relate generally to digital measurement systems.

### BACKGROUND

Utility poles can be difficult and resource intensive to measure. Utility poles can be 30 feet to 120 feet tall and can carry various loads including dangerous, high-voltage power lines. Due to the age of some poles, accurate records of their measurements including usage information is challenging to compile. When installing and servicing utilities, telecommunication and other construction companies need to determine the size of poles as well as the attached components.

Physically measuring utility poles can be dangerous, inaccurate, and time-consuming. Therefore, there is a long-felt but unresolved need for digitally measuring and collecting information for utility poles and of types of infrastructure.

### BRIEF SUMMARY OF THE DISCLOSURE

Briefly described, and according to one embodiment, aspects of the present disclosure generally relate to systems and processes for digitally measuring infrastructure, including but not limited to, utility poles, signs, streetlights, bridges, tunnels, pipes, or any other type of structure. Users of the disclosed system can capture a video feed of an object to be measured. The computing device can execute code to generate an measuring object corresponding to a digital ruler or measurement tool. The system can place the measuring object in a model of the content of the video feed including the object. The measuring object can be placed in the model on the same plane as the object to be measured. A dimension of the object, such as height, length, width, or depth, can be measured using the digital measurement too.

A camera can capture a video feed containing a first object. The camera can be within a mobile device, such as a smart phone. As will be understood, object refers to any object that can measured, including but not limited to, utility poles, signs, streetlights, bridges, tunnels, pipes, or any other type of structure. The video feed can be rendered by a computing device on a display in real time. The system can identify the first object using image recognition and object detection techniques. The system can also identify the first object based on input received at the computing device or camera.

The system can identify a plane associated with the first object. As an example, the object can be a utility pole located along a vertical axis in a Cartesian coordinate system. The system can identify a plane on the horizontal or rotational axis. After identifying a plane associated with the first object, the system can place a second object on the plane. As will be understood, the second object can be a particular pixel design embodying a digital ruler or measurement too. The particular pixel design can include more than one fixed points, each fixed point separated by a defined number of pixels. The defined number of pixels can be represent a dimension measurement, such as height, length, or depth. The second object can be placed parallel to and adjacent to the first object. The second object can be rendered in real time in the video feed. The position of the second object can be maintained as the camera moves and adjusts over time.

The system can use the particular pixel design to determine sizing metadata. The system can calculate a measurement for the first object using the sizing metadata. As an example, the first object can be a utility pole and the measurement can be the height of the pole. The system can also identify components located on the pole. The components can include connections for power lines or public utilities as well as equipment such as transformers, electrical boxes, or street lights. The system can determine the positions of the components on the first object based on the sizing metadata or the measurement of the first object.

According to a first aspect, a non-transitory computer-readable medium embodying a program that, when executed by at least one computing device, causes the at least one computing device to: A) capture a video feed from a camera comprising a plurality of frames; B) render the video feed from the camera on a display in real time; C) analyze the video feed to identify a first object depicted in the video feed; D) identify plane associated to the first object in the video feed; E) place a second object onto the plane in the video feed, the second object comprising a particular pixel design; F) render the second object in the video feed on the display in real time; G) capture an image comprising the first object and the second object from the video feed; H) determine sizing metadata based on the particular pixel design and the image; and I) calculate a measurement of the first object based on the sizing metadata.

According to the non-transitory computer-readable medium of the first aspect or any other aspect, wherein the first object is oriented along a first axis and the program further causes the at least one computing device to: A) determine an end of the first object along the first axis; and B) identify the plane associated to the first object in the video feed based on the end of the the first object.

According to the non-transitory computer-readable medium of the first aspect or any other aspect, wherein the plane is perpendicular to the first axis.

According to the non-transitory computer-readable medium of the first aspect or any other aspect, wherein the program further causes the at least one computing device to maintain a position of the second object on the plane over time.

According to the non-transitory computer-readable medium of the first aspect or any other aspect, wherein the program further causes the at least one computing device to render the second object parallel to the first object and with the first object touching the second object.

According to the non-transitory computer-readable medium of the first aspect or any other aspect, wherein the program further causes the at least one computing device to: A) identify a plurality of components associated with the first object; and B) determine a plurality of component positions along the first object individually corresponding to a respective one of the plurality of components based on the measurement of the first object.

According to the non-transitory computer-readable medium of the first aspect or any other aspect, wherein the measurement comprises a height of the first object.

According to a second aspect, a system comprising: A) a data store; and B) at least one computing device in communication with the data store, the at least one computing device configured to: 1) capture a video feed from a camera comprising a plurality of frames; 2) render the video feed from the camera on a display in real time; 3) analyze the video feed to identify a first object depicted in the video feed; 4) identify plane associated to the first object in the video feed; 5) place a second object onto the plane in the video feed, the second object comprising a particular pixel design; 6) render the second object in the video feed on the display in real time; 7) capture an image comprising the first object and the second object from the video feed; 8) determine sizing metadata based on the particular pixel design and the image; and 9) calculate a measurement of the first object based on the sizing metadata.

According to the system of the second aspect or any other aspect, wherein the at least one computing device is further configured to: A) identify at least one text segment on the first object in the image; B) determine the at least one text segment by performing image recognition on the at least one text segment in the image; and C) store the image, the sizing metadata, the measurement, and the at least one text segment in the data store associated with a positioning location of the first object.

According to the system of the second aspect or any other aspect, wherein the at least one computing device is further configured to: A) generate a request to capture data for a plurality of objects, wherein the plurality of objects comprises the first object; B) identify a user account associated with a mobile computing device of the at least one computing device; and C) assign the first object to the user account, wherein the mobile computing device comprises the camera.

According to the system of the second aspect or any other aspect, wherein the at least one computing device is further configured to store the image in the data store associated with a location of the camera when the image was captured.

According to the system of the second aspect or any other aspect, further comprising a LIDAR sensor, wherein the at least one computing device is further configured to: A) determine a distance of the first object from the camera based on a LIDAR measurement from the LIDAR sensor; and B) determine the sizing metadata further based on the distance.

According to the system of the second aspect or any other aspect, wherein the image is further stored with at least one additional sensor measurement and the at least one computing device is further configured to determine an orientation of the camera based on the at least one additional sensor measurement.

According to a third aspect, a method comprising: A) capturing, via at least one computing device, a video feed from a camera comprising a plurality of frames; B) rendering, via the at least one computing device, the video feed from the camera on a display in real time; C) analyzing, via the at least one computing device, the video feed to identify a first object depicted in the video feed; D) identifying, via the at least one computing device, plane associated to the first object in the video feed; E) placing, via the at least one computing device, a second object onto the plane in the video feed, the second object comprising a particular pixel design; F) rendering, via the at least one computing device, the second object in the video feed on the display in real time; G) capturing, via the at least one computing device, an image comprising the first object and the second object from the video feed; H) determining, via the at least one computing device, sizing metadata based on the particular pixel design and the image; and I) calculating, via the at least one computing device, a measurement of the first object based on the sizing metadata.

According to the method of the third aspect or any other aspect, wherein the video feed is a live feed from the camera.

According to the method of the third aspect or any other aspect, wherein analyzing the video feed comprises generating, via the at least one computing device, a three-dimensional model of the video feed.

According to the method of the third aspect or any other aspect, wherein calculating the measurement of the first object based on the sizing metadata comprises applying, via the at least one computing device, a linear algebra algorithm to the image using the sizing metadata.

According to the method of the third aspect or any other aspect, further comprising: A) determining, via the at least one computing device, a first location of the camera; and B) calculating, via the at least one computing device, a second location of the first object based on the first location and the sizing metadata.

According to the method of the third aspect or any other aspect, further comprising: A) capturing, via the at least one computing device, a plurality of initial images associated with the first object from a plurality of perspectives; and B) calibrating, via the at least one computing device, the at least one computing device for determining the sizing metadata.

According to the method of the third aspect or any other aspect, further comprising: A) identifying, via the at least one computing device, a plurality of measurement data sets associated with a plurality of objects at a plurality of locations, wherein one of the plurality of measurement data sets comprises the measurement of the first object; and B) generating, via the at least one computing device, a map of an area comprising the plurality of objects individually located at a corresponding one of the plurality of locations.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary digital measurement system;

FIG. 2 illustrates an exemplary view of the video feed;

FIG. 3A illustrates an exemplary pixel design;

FIG. 3B illustrates an exemplary enlarged pixel design;

FIG. 4 illustrates an exemplary networked environment;

FIG. 5 illustrates an exemplary high-level overview process;

FIG. 6 illustrates an exemplary process for identifying a first object and rendering a second object in a video feed;

FIG. 7 illustrates an exemplary process for determining sizing metadata and calculating a measurement for the first object;

FIG. 8 illustrates an exemplary map;

FIG. 9 illustrates an exemplary process for identifying text segments on the first object; and

FIG. 10 for identifying and assigning a user to capture a video feed.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and processes for digitally measuring infrastructure, including but not limited to, utility poles, signs, streetlights, bridges, tunnels, pipes, or any other type of structure. Users of the disclosed system can capture a video feed of an object to be measured. A digital ruler or measurement tool can be rendered in the video feed next to the object. A dimension of the object, such as height, length, width, or depth, can be measured using the digital measurement too.

The disclosed system can include a computing environment connected to one or more computing devices via a network. The computing devices can include cameras and/or sensors. The computing devices can also be connected to cameras and/or sensors via the network. A camera can capture a video feed containing a first object. As will be understood, object refers to any object that can measured, including but not limited to, utility poles, signs, streetlights, bridges, tunnels, pipes, or any other type of structure. The video feed can be rendered on a computing device in real time. The system can analyze the video feed. For example, the computing device can generate a three-dimensional model of the video feed using photogrammetry three-dimensional modeling. The computing device can also generate a three-dimensional model of the video feed using measurements from a LIDAR sensor. The system can identify the first object using image recognition and object detection techniques. The system can also identify the first object based on input received at the computing device or camera.

The system can identify a plane associated with the first object. As an example, the object can be a utility pole located along a vertical axis in a Cartesian coordinate system. The system can identify a plane on the horizontal or rotational axis. The system can also identify an end of the object. For example, the system can identify an end of the first object located along an axis. The system can use the location of the end of the first object to determine the orientation of the first object along the axis.

After identifying a plane associated with the first object, the system can place a second object on the plane. As will be understood, the second object can be a particular pixel design embodying a digital ruler or measurement tool. The particular pixel design can include more than one fixed points, each fixed point separated by a defined number of pixels. The defined number of pixels can be represent a dimension measurement, such as height, length, or depth. For example, the defined number of pixels separating two fixed points could each represent one foot. The second object can be placed parallel to and adjacent to the first object. The second object can also be placed based on the location of the end of the first object. The second object can be rendered in real time in the video feed. The position of the second object can be maintained as the camera moves and adjusts over time.

The system can use the particular pixel design to determine sizing metadata. Determining the sizing metadata can include locating each fixed point on the particular pixel design in the image. The system can apply the Pythagorean Theorem to measure the Euclidean distance between each fixed point on the particular pixel design. Each fixed point can be associated with a dimension measurement based on the particular pixel design to form a data point. The least squares method can be applied to two or more data points to determine a least squares solution.

The system can calculate a measurement for the first object using the sizing metadata. The system can calculate a measurement for the first object using the least squares solution. As an example, the first object can be a utility pole and the measurement can be the height of the pole. The system can also identify components located on the pole. The components can include connections for power lines or public utilities as well as equipment such as transformers, electrical boxes, or street lights. The system can determine the positions of the components on the first object based on the sizing metadata or the measurement of the first object.

The system can generate a map including the location of the first object and multiple other objects. The location of the object can be determined based on the location of the camera or the computing device at the time of capturing the video feed.

The system can also generate requests for users to generate capture data. The request can specify an area and multiple object in that area. Users can capture a video feed of the area including the objects listed in the request.

### Exemplary Embodiments

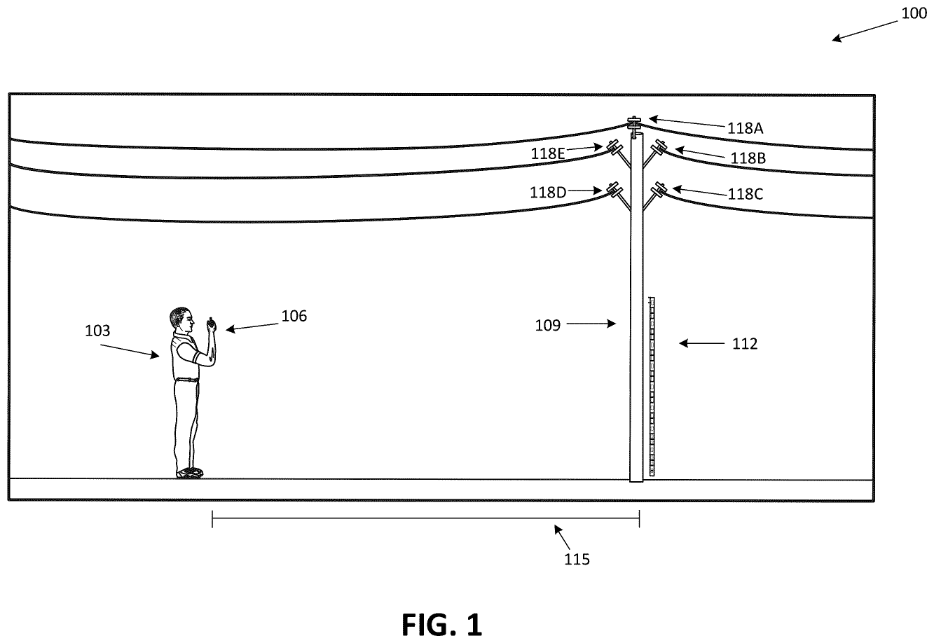

Referring now to the figures, for the purposes of example and explanation of the fundamental processes and components of the disclosed systems and processes, reference is made to FIG. 1, which illustrates an exemplary digital measurement system 100 disclosed herein. As will be understood and appreciated, the exemplary digital measurement system 100 shown in FIG. 1 represents merely one approach or embodiment of the present system, and other aspects are used according to various embodiments of the present system.

The digital measurement system 100 can include a user 103, a computing device 106, a first object 109, and a pixel design 112. The user 103 can be any user of system 100. The user 103 can operate the computing device 106. The computing device 106 can be any computing device capable of accessing a network and can include one or more processors and displays. The computing device 106 can include one or more cameras or sensors. As an example, the computing device 106 can be a mobile computing device with a camera and a display.

The computing device 106 and the first object 109 can be separated by a distance 115. The first object 109 can be a utility pole (e.g., a column to support overhead power lines and utility cables). The first object 109 can also be other types of infrastructure including, but not limited to, signs, streetlights, bridges, tunnels, or pipes. The first object 109 can also be a building or other type of structure. As an example, the first object 109 can be a utility pole including components 118A, 118B, 118C, 118D, and 118E. The components 118A, 118B, 118C, 118D, and 118E can be connection points for power lines or other utility cables or can be equipment such as transformers, electrical boxes, or street lights.

The user 103 can use the computing device 106 to capture a video feed. The user 103 can position the computing device 106 such that the first object is shown in the video feed. The digital measurement system 100 and the computing device 106 can identify the first object and place the pixel design 112 in the video feed. The computing device 106 can generate model of objects in the video feed. The computing device 106 can determine a plane corresponding to the base of the first object. The computing device 106 can place the pixel design 112 object on the plane corresponding to the base of the first object. As an example, the computing device 106 can place the pixel design 112 parallel to and adjacent to the first object 109 in the video feed captured by the computing device 106. In some embodiments, the digital measurement system 100 can place the pixel design 112 in the video feed captured by the computing device 106 without any input from the user 103.

The pixel design 112 can represent a digital ruler or measurement tool. The pixel design 112 can include multiple fixed points representing a distance. For example, the pixel design can have fixed points representing a foot in length. The computing device 106 can use the pixel design 112 to calculate a measurement for the first object 109. As an example, the computing device 106 can use the pixel design 112 to calculate a height of the first object 109. The computing device 106 can be calibrated using the distance 115.

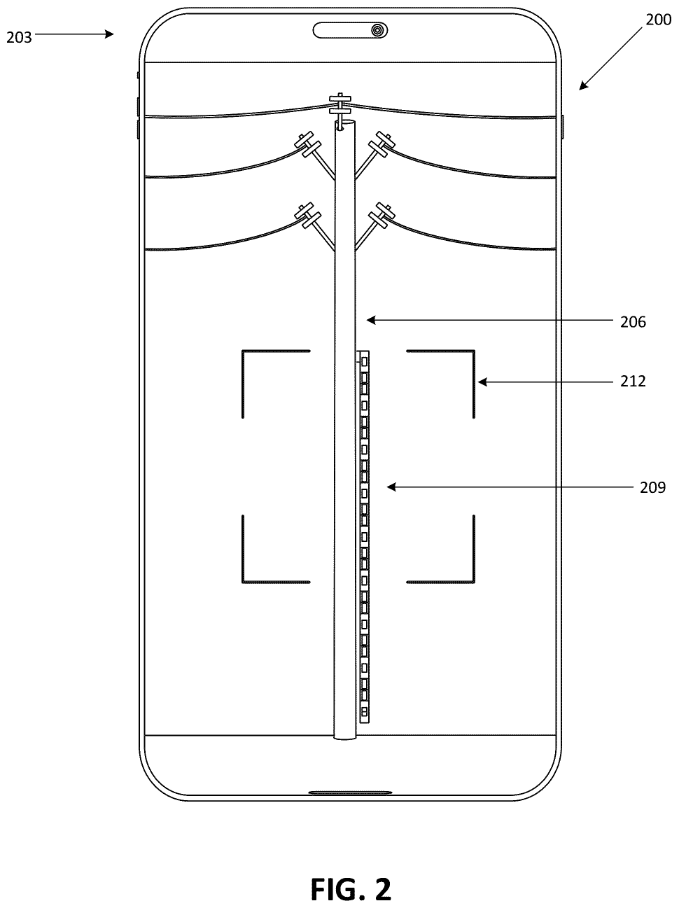

Referring now to FIG. 2, shown is an exemplary video feed 200 according to various embodiments of the present disclosure. The computing device 106 can display the video feed 200 on a display. The video feed 200 can depict, display, or include the first object 206. The computing device 106 can place the pixel design 112 in the video feed 200. The computing device 106 can use the pixel design 112 to calculate a measurement for the first object 206. The video feed 200 can include indicators 212 (e.g., brackets displayed on the video feed 200) to ensure that the first object 206 is positioned in the center of the video feed 200.

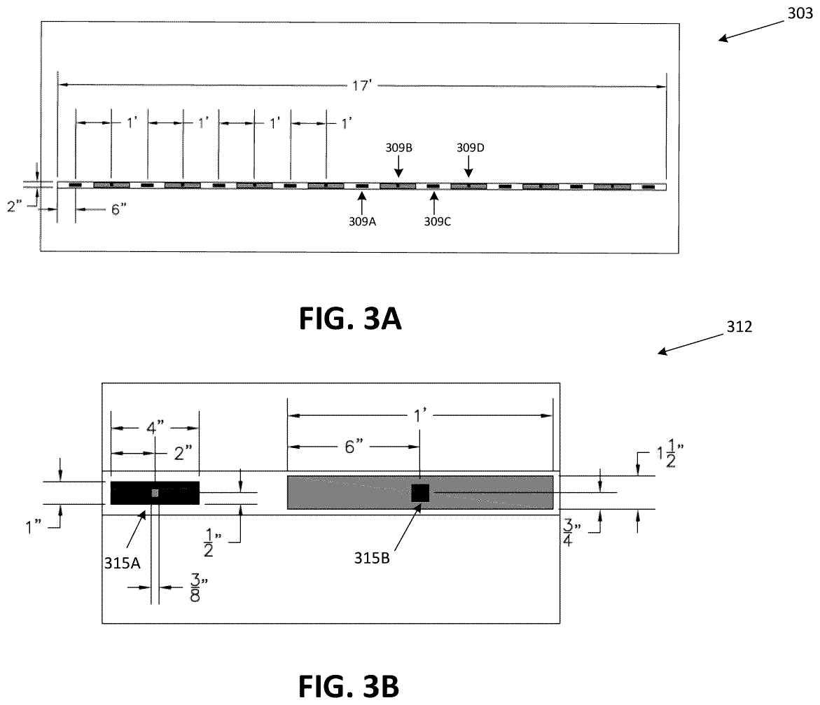

Referring now to FIG. 3A, shown is an exemplary pixel design 303 according to various embodiments of the present disclosure. The pixel design 303 can correspond to a pixel design 112. The pixel design 303 can represent any appropriate length (e.g., a sufficient length to calculate a measurement of an object in a video feed). As an example, the pixel design 303 can represent 17 feet in length. The pixel design 303 can include multiple fixed points, including but not limited to fixed points 309A, 309B, 309C, and 309D. The fixed points 309A, 309B, 309C, and 309D can each be separated by a defined number of pixels. The defined number of pixel can represent a dimension measurement, such as height, length, or depth. The defined number of pixels can represent any appropriate dimension measurement (e.g., a sufficient dimension to calculate a measurement of an object in a video feed). As an example, the defined number of pixels between fixed points 309A. 309B, 309C, and 309D can represent 1 foot (e.g., the defined number of pixels between fixed point 309A and fixed point 309B represents 1 foot). The pixel design 303 can include any appropriate number of fixed points. As an example, since the pixel design 303 can represent 17 feet and the defined number of pixels can represent 1 foot each, then the pixel design 303 can include 17 fixed points, including but not limited to, fixed points 309A, 309B, 309C, and 309D.

Referring now to FIG. 3B, shown is an exemplary enlarged pixel design 312 according to various embodiments of the present disclosure. The enlarged pixel design 312 can be an enlarged portion of the pixel design 112/303. The enlarged pixel design 312 can include multiple fixed points, including but not limited to, fixed points 315A and 315B. Similar to fixed points 309A, 309B, 309C, and 309D shown in FIG. 3A, fixed points 315A and 315B can each be separated by a defined number of pixels. The defined number of pixel can represent a dimension measurement, such as height, length, or depth. The defined number of pixels can represent any appropriate dimension measurement (e.g., a sufficient dimension to calculate a measurement of an object in a video feed). As an example, the defined number of pixels between fixed points 315A and 315B can represent 1 foot.

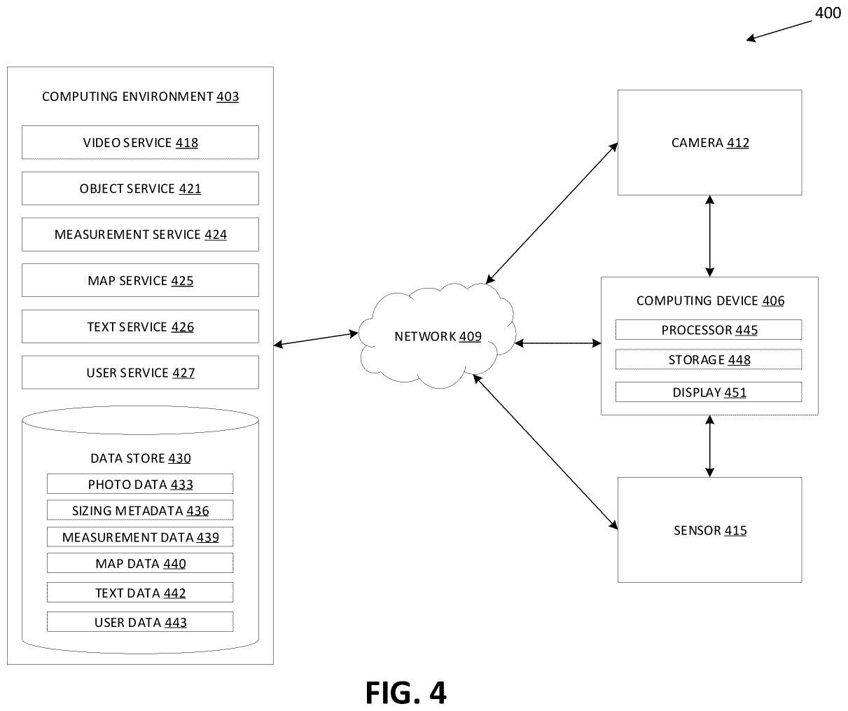

Referring now to FIG. 4, shown is an exemplary networked environment 400 for the digital measurement systems according to various embodiments of the present disclosure. As will be understood and appreciated, the exemplary networked environment 400 shown in FIG. 4 represents merely one approach or embodiment of the present system, and other aspects are used according to various embodiments of the present system. The networked environment 400 can include, but is not limited to, a computing environment 403 connected to one or more computing devices 406 over a network 409. The computing device 406 can be a computing device 106. The computing devices 406 can include or be communicatively connected to one or more cameras 412 and one or more sensors 415. In some embodiments, the cameras 412 and sensors 415 can also be devices separate from and communicable coupled to the computing device 406. The cameras 412 and sensors 415 can be connected to computing environment 403 and computing device 406 over the network 409.

The elements of the computing environment 403 can be provided via a plurality of computing devices that may be arranged, for example, in one or more server banks or computer banks or other arrangements. Such computing devices can be located in a single installation or may be distributed among many different geographical locations. For example, the computing environment 403 can include a plurality of computing devices that together may include a hosted computing resource, a grid computing resource, or any other distributed computing arrangement. In some cases, the computing environment 403 can correspond to an elastic computing resource where the allotted capacity of processing, network, storage, or other computing-related resources may vary over time. Regardless, the computing environment 403 can include one or more processors and memory having instructions stored thereon that, when executed by the one or more processors, cause the computing environment 403 to perform one, some, or all of the actions, methods, steps, or functionalities provided herein.

The computing environment 403 can include a video service 418, an object service 421, a measurement service 424, a map service 425, a text service 426, a user service 427 and data store 430. In some embodiments, the video service 418, the object service 421, the measurement service 424, the map service 425, the text service 426, and the user service 427 can correspond to one or more software executables that can be executed by the computing environment 403 to perform the functionality described herein. While the video service 418, the object service 421, the measurement service 424, the map service 425, the text service 426, and the user service 427 are described as different services, it can be appreciated that the functionality of these services can be implemented in one or more different services executed in the computing environment 403. Various data can be stored on data store 430, including but not limited to, photo data 433, sizing metadata 436, measurement data 439, map data 440, text data 442, and user data 443.

The video service 418 can receive a video feed from the camera 412. The video feed can be a live video from the camera 412. The video service 418 can render the video feed in real time on a display. The video service 418 can also render objects in the video feed in real time. The video service 418 can capture images from the video feed for analysis by the object service 421 and the measurement service 424. The video service 418 can store the image and location of camera 412 as photo data 433 in the data store 430.

The object service 421 can analyze the video feed from the camera 412. The object service 421 can identify a first object in the video feed. The object can be a utility pole (e.g., a column to support overhead power lines and utility cables). The utility pole can include one or more connection points for power lines or public utilities. The utility pole can also include other equipment such as transformers, electrical boxes, or street lights. The object can also be other types of infrastructure including, but not limited to, signs, streetlights, bridges, tunnels, or pipes. The object can also be a building or other type of structure.

After identifying a first object, the object service 421 can generate a multi-dimensional model of the video fees including the first object. The object service 421 can identify a plane associated with the first object in the multi-dimensional model. The first object can be located along (e.g., parallel to or oriented along) an axis in a Cartesian coordinate system. The object service 421 can identify a plane along the same axis or one of the perpendicular axes. The object service 421 can identify the plane associated with the first object by identifying an end of the first object. The object service 421 can identify an end (e.g., a top end, bottom end, edge, side) of the first object. The object service 421 can locate the end along an axis to determine the orientation of the first object along the axis. The object service 421 can identify the plane based on the location of the end of the first object along the axis.

The object service 421 can place a second object on the identified plane. The second object can be the pixel design 112. The object service 421 can place the second object parallel to and adjacent (e.g., touching) the first object. After placing the second object on the plane, the object service 421 can maintain the position of the second object on the plane as the camera 412 moves and adjusts.

The measurement service 424 can determine sizing metadata based on the particular pixel design. The measurement service 424 can use the fixed points on the particular pixel design to determine a number of known measurements on the first object. The measurement service 424 can apply the least squares method to the fixed points and known measurements to determine a least squares solution. The least squares solution determined by the measurement service 424 can be stored as the sizing metadata 436 in the data store 430.

The measurement service 424 can calculate a measurement of the first object based on the sizing metadata. The measurement service 424 can use the least squares solution to calculate a measurement of the first object. The measurement can be any dimension, including but not limited to height, length, or width. The measurement can be the height of the first object. The measurement can be the height of a component that is attached to the first object. The measurement can be the height of any location on the first object. The measurement service 424 can store the calculated measurement in the data store as measurement data 439.

The map service 425 can generate a map indicating the locations of multiple objects. For example, the map service 425 can receive the locations of multiple objects in an area. The map service 425 can generate a map with flags, each flag indicating the location of an object. The map service 425 can store the generated maps at map data 440

The text service 426 can identify text from the images captured by the camera 412. The text identified by the text service 426 can be located on an object in an image. The text service 426 can perform image recognition on the text to determine the contents of the text. The text service 426 can store the text as text data 442.

The user service 427 can identify and assign a user to capture a video feed of multiple objects. For example, the user service 427 can generate a request for a user to capture a video feed in a specific area including multiple objects. The user service 427 can generate a list of potential users, identify a particular user from the list, and assign the particular user to the request. The user service 427 can store the request, the list of users, and the particular user as user data 443.

The computing device 406 can be any device capable of accessing network 409 including, but not limited to, a computer, smartphone, tablets, or other device. The computing device 406 can include a processor 445 and storage 448. The computing device 406 can include a display 451 on which various user interfaces can be rendered to allow users to configure, monitor, control, and command various functions of networked environment 400. The computing device 406 can include or be connected to cameras 412 and/or sensors 415. In some embodiments, the computing device 406 can include multiple computing devices. The computing device 406 can include one or more processors and memory having instructions stored thereon that, when executed by the one or more processors, cause the computing device 406 to perform one, some, or all of the actions, methods, steps, or functionalities provided herein.

The computing device 406 can generate a three-dimensional model of the video feed captured by camera 412. The computing device 406 can also generate a three-dimensional model of an object in the video feed captured by camera 412. The computing device 406 can use photogrammetry methods to generate the three-dimensional model. The computing device 406 can also generate a three-dimensional model of an object from the LIDAR measurements from sensors 415.

The network 409 includes, for example, the Internet, intranets, extranets, wide area networks (WANs), local area networks (LANs), wired networks, wireless networks, or other suitable networks, etc., or any combination of two or more such networks.

The one or more cameras 412 can be a component of or communicatively connected to computing device 406. The camera 412 can capture a live video feed in real life. The video feed captured by camera 412 can be rendered on display 451. The video feed can include multiple frames per second (“FPS”) (e.g., 24 FPS, 25 FPS, 30 FPS, 120 FPS).

The one or more sensors 415 can be LIDAR sensors, three-axis gyrometer sensors, accelerometer sensors, ambient light sensors, or any other appropriate sensors. The measurements from sensors 415 can be stored in data store 430 as measurement data 439. The computing device 406 can use the measurements from sensors 415 to determine an orientation of the camera 412. For example, sensor 415 can include a three-axis gyrometer. The computing device 406 can use the measurement from sensor 415 to determine the angle of the camera 412. The sensor 415 can include a LIDAR sensor. The computing device 406 can use the LIDAR measurements from the sensor 415 to generate a three-dimensional model of an object. The LIDAR measurements from the sensor 415 can also be used to determine a distance from the sensor 415 to an object.

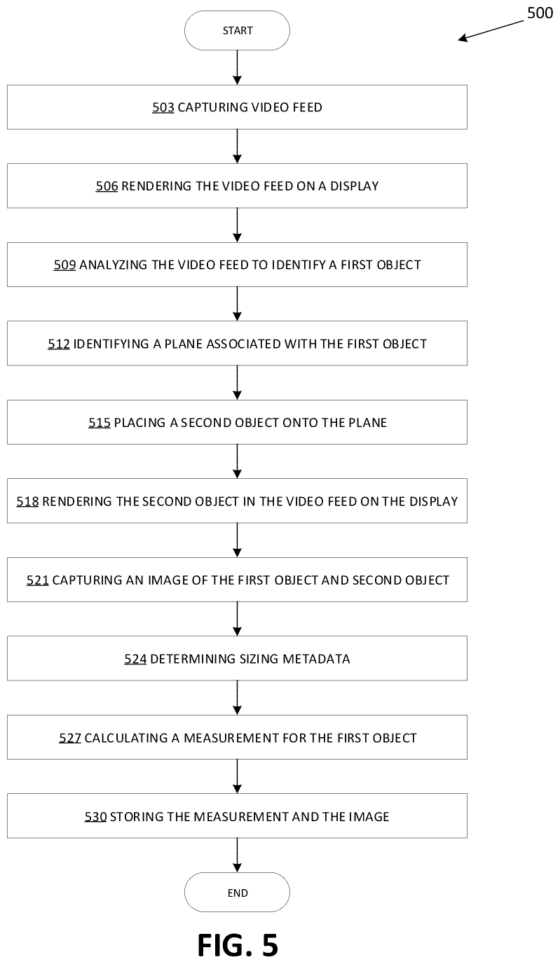

Referring now to FIG. 5, shown is an exemplary, high-level overview process 500 according to one embodiment of the present disclosure. As will be understood by one having ordinary skill in the art, the steps and processes shown in FIGS. 5-7, 9, and 10 may correspond to a method and operate concurrently and continuously, are generally asynchronous and independent, can be performed in part or in whole by a combination of one or more of the computing environment 403 and computing devices 406, and are not necessarily performed in the order shown.

At step 503, the camera 412 can capture a video feed. The video feed can include multiple frames per second (“FPS”) (e.g., 24 FPS, 25 FPS, 30 FPS, 120 FPS). At step 506, the video service 418 can render the video feed on a display in real time. The video feed can be rendered in real time. The video feed rendered can be a live video feed from the camera 412. The video feed can be rendered on display 451 of the computing device 406.

At step 509, the object service 421 can analyze the video feed. Analyzing the video feed can include identifying a first object in the video feed. The first object in the video feed can be a utility pole (e.g., a column to support overhead power lines and utility cables). The utility pole can include one or more connection points for power lines or public utilities. The utility pole can also include other equipment such as transformers, electrical boxes, or street lights. The first object can also be other types of infrastructure including, but not limited to, signs, streetlights, bridges, tunnels, or pipes. The first object can also be a building or other type of structure. Analyzing the video feed can include generating a three-dimensional model of the video feed or the first object. The computing device 406 can generate a three-dimensional model of the video feed or the first object from the video feed captured by camera 412. The computing device 406 can use photogrammetry methods to generate the three-dimensional model. The computing device 406 can also use the LIDAR measurements from sensor 415 to generate a three-dimension model.

At step 512, the object service 421 can identify a plane associated with the first object identified at step 509. The first object can be located along (e.g., parallel to or oriented along) an axis in a Cartesian coordinate system. The object service 421 can identify a plane along the same axis or one of the perpendicular axes. If the first object can be located along the vertical axis, the object service 421 can identify a plane on either the horizontal axis or rotational axis. Alternatively, if the first object can be located along the horizontal axis, the object service 421 can identify a plane on either the vertical axis or the rotational axis. Alternatively, if the first object can be located along the rotational axis, the object service 421 can identify a plane on the vertical axis or horizontal axis.

The object service 421 can identify the plane associated with the first object by identifying an end of the first object. The object service 421 can identify an end (e.g., a top end, bottom end, edge, side) of the first object. The object service 421 can locate the end along an axis to determine the orientation of the first object along the axis. The object service 421 can identify the plane based on the location of the end of the first object along the axis.

At step 515, the object service 421 can place a second object on the plane identified at step 512. The second object can be a particular pixel design 112. The particular pixel design 112 can include more than one fixed points, each fixed point separated by a defined number of pixels. The defined number of pixels can be represent a dimension measurement, such as height, length, or depth. The object service 421 can place the second object parallel to and adjacent (e.g., touching) the first object. The object service 421 can place the second object perpendicular to the first object. The object service 421 can orient the second object based on the location of the end of the first object. After placing the second object on the plane, the object service 421 can maintain the position of the second object on the plane. The object service 421 can maintain the position of the second object as the camera 412 moves or adjusts. The object service 421 can maintain the position of the second object as the video feed continues over time.

At step 518, the video service 418 can render the second object in the video feed on a display in real time. The video service 418 can render the second object in a live video feed. The second object can be rendered in the video feed on display 451 of the computing device 406. The video service 418 can continue to render the second object as camera 412 moves or adjusts. At step 521, the video service 418 can capture an image of the video feed. The image captured by video service 418 can include the first object and the second object. In the image, the second object can be parallel to and adjacent to (e.g., touching) the first object. The image can be a frame from the video feed captured by camera 412. The image can be displayed on display 451 of the computing device 406.

At step 524, the measurement service 424 can determine the sizing metadata. The sizing metadata can be determined based on the particular pixel design 112 and the image. The fixed points on the particular pixel design can be separated by a defined number of pixels. The defined number of pixel can represent a dimension measurement, such as height, length, or depth.

Determining the sizing metadata can include locating each fixed point on the particular pixel design 112 in the image. The measurement service 424 can locate each fixed point on the particular pixel design 112 in the image. For example, the measurement service 424 can designate any fixed point on the particular pixel design 112 as the origin in a Cartesian coordinate system (e.g., coordinates (0,0)) on the plane identified at step 512. The measurement service 424 can then identify coordinates for other fixed points on the particular pixel design 112. The coordinates identified by the measurement service 424 can be the number of pixels separating a fixed point on the particular pixel design 112 with the fixed point designated as the origin (e.g., the fixed point can be 20 pixels to the right of and 30 pixels above the fixed point designated as the origin). After identifying coordinates, the measurement service 424 can use the Pythagorean Theorem to measure the Euclidean distance between any two fixed points. The calculated Euclidean distance can represent the distance between the two fixed points in pixels. The Euclidean distance can be associated with a dimension measurement based on the defined number of pixels in the particular pixel design 112 to form a data point. The measurement service 424 can apply the least squares method to two or more data points to determine a least squares solution. The coordinates for the fixed points on the particular pixel design 112, the Euclidean distances between the fixed points, the associated dimension measurements, and the least squares solution can be stored as the sizing metadata 436.

At step 527, the measurement service 424 can calculate a measurement of the first object based on the sizing metadata. The measurement service 424 can use the least squares solution from step 525 to calculate a measurement of the first object. The measurement can be any dimension, including but not limited to height, length, or width. The measurement can be the height of the first object. The measurement can be the height of a component that is attached to the first object. The measurement can be the height of any location on the first object. At step 530, the image and the measurement data can be stored in the data store 430. The image can be stored as photo data 433. The image can also be stored with the location of the camera 412 when the image was captured. The measurement can be stored as measurement data 439.

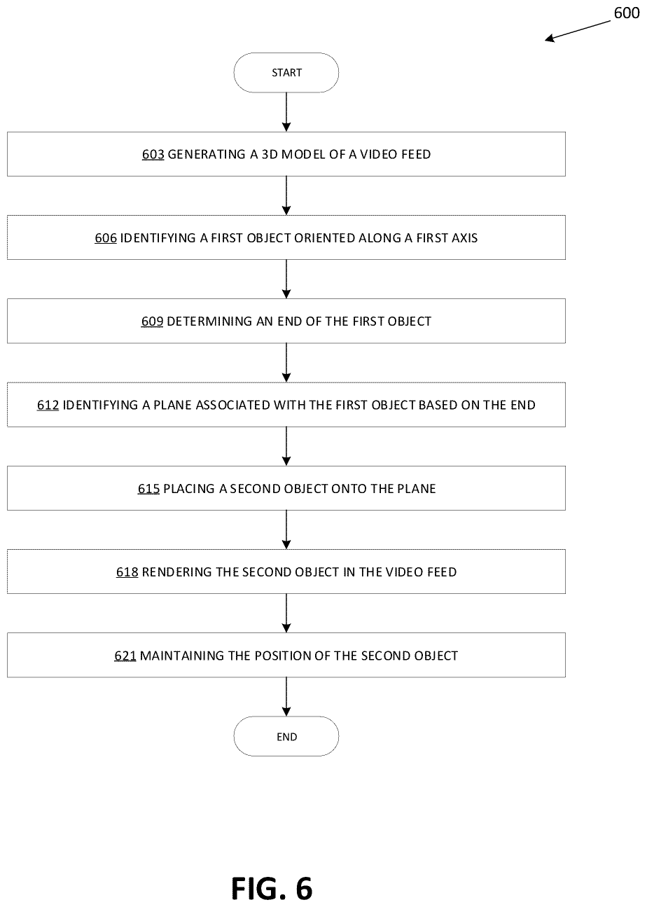

Referring now to FIG. 6, process 600 shows an exemplary process for identifying a first object in a video feed and rendering a second object in the video feed according to various embodiments of the present disclosure. At step 603, the computing device 406 can generate a three-dimensional model of the video feed captured by camera 412. The computing device 406 can also generate a three-dimensional model of an object in the video feed captured by camera 412. The computing device 406 can use photogrammetry methods to generate the three-dimensional model. The computing device 406 can also generate a three-dimensional model of an object from the LIDAR measurements from the sensors 415.

The computing device 406 can apply photogrammetry methods to generate a three-dimensional model of the video feed or an object in the video feed. By applying photogrammetry methods, the computing device 406 can extract multiple, overlapping frames from the video feed. The computing device 406 can use to location of the camera 412 to estimate the location of each pixel from a particular frame of the video feed. The computing device 406 can stitch together the frames and the location of the pixels in the frames to generate the three-dimensional model.

The computing device 406 can also use the LIDAR measurements from sensors 415 to generate a three-dimensional model of the video feed or an object in the video feed. The sensors 415 can receive LIDAR measurements of an area while camera 412 can capture a video feed of the same area, either simultaneously or concurrently. The computing device 406 can use the LIDAR measurements from the sensors 415 to generate a three-dimensional model of the area in the video feed captured by the camera 412.

At step 606, the object service 421 can identify a first object in the video feed. The first object in the video feed can be a utility pole (e.g., a column to support overhead power lines and utility cables). The utility pole can include one or more connection points for power lines or public utilities. The utility pole can also include other equipment such as transformers, electrical boxes, or street lights. The first object can also be other types of infrastructure including, but not limited to, signs, streetlights, bridges, tunnels, or pipes. The first object can also be a building or other type of structure.

The object service 421 can identify the first object in the video using object detection methods. As will be understood by one having ordinary skill in the art, the object service 421 can apply computer vision and image processing techniques, including object recognition, object localization, image classification, and object detection to the frames from the video feed to detect the first object. The object service 421 can also identify the first object in the video feed based on input from the computing device 406 and the camera 412. The computing device 406 can receive a user indication of the presence of the first object via a touch screen display. The computing device 406 can receive one or more inputs, such as from a user, to orient the camera 412 so that the first object is within a specified area of the video feed. In some embodiments, the computing device 406 can orient the camera 412 based on analyzing the video feed. As an example, the computing device 406 can digitally isolate a desired portion of the video feed from the camera 412 to orient the video feed. In another embodiment, the computing device 406 can adjust one or more properties of the camera 412 to orient the video feed. The properties can include physically adjusting the direction of the camera (e.g., via pan, tilt, and zoom or by causing one or more mechanical components to move), changing sensor sensitivities for the camera 412, or aperture properties, such as f-stop or shutter speed.

At step 609, the object service 421 can determine an end (e.g., a top end, bottom end, edge, side) of the first object. The first object can be located along (e.g., parallel to or oriented along) an axis in a Cartesian coordinate system. For example, the first object can be a utility pole located along a vertical axis. The object service 421 can identify the bottom end of the utility pole (e.g., where the utility pole meets the ground) along the vertical axis.

The object service 421 can determine an end of the first object using object recognition, object localization, image classification, and object detection methods. The object service 421 can also determine the end based on input from the computing device 406 and the camera 412. A user can indicate the location of the end of the first object via the computing device 406 and/or the camera 412. A user can also orient the camera 412 so that the end of the first object is within a specified area of the video feed.

At step 612, the object service 421 can identify a plane associated with the first object based on the end. The first object can be located along (e.g., parallel to or oriented along) an axis in a Cartesian coordinate system. The object service 421 can identify a plane along the same axis or one of the perpendicular axes. For example, if the first object can be located along the vertical axis, the object service 421 can identify a plane on either the horizontal axis or rotational axis. In another example, if the first object can be located along the horizontal axis, the object service 421 can identify a plane on either the vertical axis or the rotational axis. In another example, if the first object can be located along the rotational axis, the object service 421 can identify a plane on the vertical axis or horizontal axis. The object service 421 can locate the end along an axis to determine the orientation of the first object along the axis. The object service 421 can identify the plane based on the location of the end of the first object along the axis.

At step 615, the object service 421 can place a second object on the plane identified at step 612. The second object can be a particular pixel design 112. The particular pixel design 112 can include more than one fixed points, each fixed point separated by a defined number of pixels. The defined number of pixels can be represent a dimension measurement, such as height, length, or depth. The particular pixel design 112 can be the particular pixel design 112 shown in FIG. 3A.

The object service 421 can place the second object based on the location of the first object in the video feed. The object service 421 can also place the second object based on input from the computing device 406 and the camera 412. A user can indicate the location for placing the second object via the computing device 406 and/or the camera 412. The object service 421 can place the second object parallel to and adjacent (e.g., touching) the first object. The object service 421 can place the second object perpendicular to the first object. The object service 421 can orient the second object based on the location of the end of the first object.

At step 618, the video service 418 can render the second object in the video feed on a display in real time. The video service 418 can render the second object in a live video feed. The second object can be rendered in the video feed on display 451 of the computing device 406. At step 621, the object service 421 can maintain the position of the second object on the plane. The object service 421 can maintain the position of the second object on the plane. The object service 421 can maintain the position of the second object as the camera 412 moves or adjusts. The object service 421 can maintain the position of the second object as the video feed continues over time.

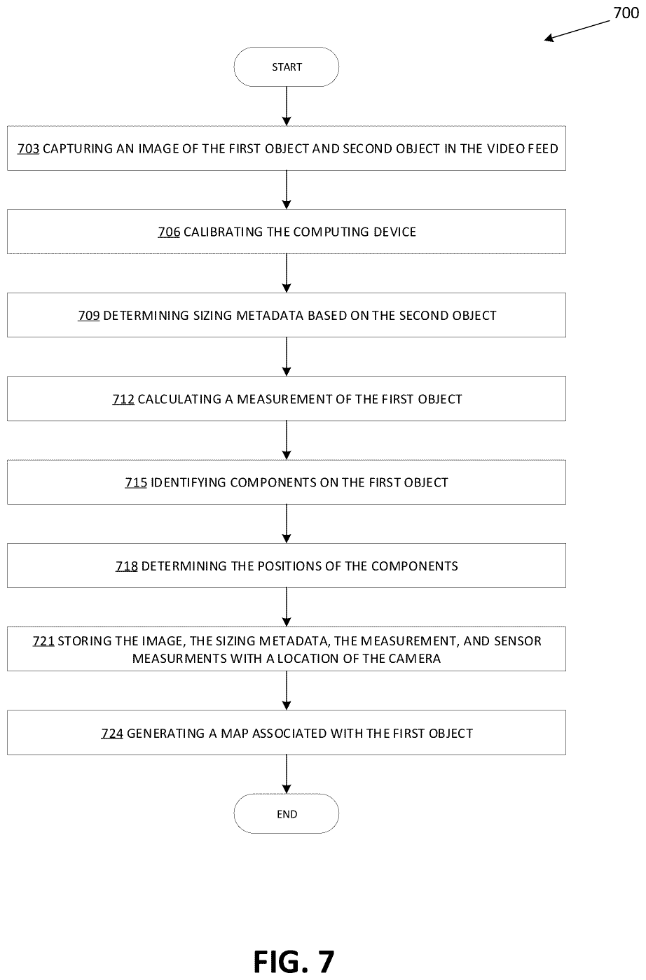

Referring now to FIG. 7, process 700 shows an exemplary process for determining sizing metadata and calculating a measurement for the first object according to various embodiments of the present disclosure. At step 703, the video service 418 can capture an image of the video feed. The image captured by video service 418 can include the first object and the second object. In the image, the second object can be parallel to and adjacent to (e.g., touching) the first object. The image can be a frame from the video feed captured by camera 412. The image can be displayed on display 451 of the computing device 406.

At step 706, the measurement service 424 can calibrate the computing device 406. The measurement service 424 can calibrate the computing device 406 based on the location of the camera 412 and the computing device 406. The measurement service 424 can determine the location of the camera 412. Based on the location of the camera 412. the measurement service 424 can determine the location of the first object. The measurement service 424 can also calibrate the computing device 406 based on a LIDAR measurement from sensors 415. For example, the sensor 415 and the camera 412 can be positioned in the same location (e.g., the sensor 415 and the camera 412 can be components of the same computing device 406, the sensor 415 and the camera 412 can be located next to each other). The sensor 415 can use LIDAR measurement to determine the distance between the first object and the sensor 415. The LIDAR measurement can be used to determine the distance between the first object and the camera 412. The distance can be used to calibrate the computing device 406.

The measurement service 424 can also calibrate the computing device 406 based on parallax measurements. As will be understood by one having ordinary skill in the art, parallax is a difference in the appearance of an object viewed along multiple lines of sight. The camera 412 can capture multiple images of the first object from different angles, perspectives, and/or sight lines. Similarly, the sensor 415 can receive multiple measurements of the first object from different angles, perspectives, and/or sight lines. For example, the sensor 415 and the camera 412 can be positioned in the same location (e.g., the sensor 415 and the camera 412 can be components of the same computing device 406, the sensor 415 and the camera 412 can be located next to each other). The measurement from the sensor 415 can be used to determine the orientation of the camera 412 in relation to the first object. As the camera 412 and sensor 415 change positions, the measurements from sensor 415 can be used to determine the angle from the initial position of the camera 412, the first object, and the new position of the camera 412. The change in position of the camera 412 or the sensor 415 can be used to calculate a distance measurement by parallax between the camera 412 or the sensor 415 and the first object. The distance can be used to calibrate the computing device 406.

At step 709, the measurement service 424 can determine the sizing metadata. The sizing metadata can be determined based on the particular pixel design 112 and the image. The fixed points on the particular pixel design 112 can be separated by a defined number of pixels. The defined number of pixel can represent a dimension measurement, such as height, length, or depth. Determining the sizing metadata can include locating each fixed point on the particular pixel design 112 in the image. The measurement service 424 can locate each fixed point on the particular pixel design 112 in the image. For example, the measurement service 424 can designate any fixed point on the particular pixel design 112 as the origin in a Cartesian coordinate system (e.g., coordinates (0,0)) on the plane identified at step 512. The measurement service 424 can then identify coordinates for other fixed points on the particular pixel design 112. The coordinates identified by the measurement service 424 can be the number of pixels separating a fixed point on the particular pixel design 112 with the fixed point designated as the origin (e.g., the fixed point can be 20 pixels to the right of and 30 pixels above the fixed point designated as the origin). After identifying coordinates, the measurement service 424 can use the Pythagorean Theorem to measure the Euclidean distance between any two fixed points. The calculated Euclidean distance can represent the distance between the two fixed points in pixels. The Euclidean distance can be associated with a dimension measurement based on the defined number of pixels in the particular pixel design 112 to form a data point. The measurement service 424 can apply the least squares method to two or more data points to determine a least squares solution. The coordinates for the fixed points on the particular pixel design 112, the Euclidean distances between the fixed points, the associated dimension measurements, and the least squares solution can be stored as the sizing metadata 436.

At step 712, the measurement service 424 can calculate a measurement of the first object based on the sizing metadata. The measurement service 424 can use the least squares solution from step 709 to calculate a measurement of the first object. The measurement can be any dimension, including but not limited to height, length, or width. For example, if the first object is a utility pole, the measurement can be the height of the pole.

At step 715, the object service 421 can identify components associated with the first object. For example, if the first object is a utility pole, the object service 421 can identify multiple connections or components on the utility pole. The components can include connections for power lines or public utilities as well as equipment such as transformers, electrical boxes, or street lights. The object service 421 can identify the components associated with the first object using computer vision and image processing techniques, including object recognition, object localization, image classification, and object detection. The object service 421 can also identify the components based on input from the computing device 406 and the camera 412. A user can indicate the presence of a component via the computing device 406 and/or the camera 412. A user can also orient the camera 412 so that the component is within a specified area of the video feed.

At step 718, the measurement service 424 can determine the positions of the components. The measurement service 424 can determine the positions of the components based on the sizing metadata or the measurement of the first object. For example, if the measurement of the first object is the height of the first object, the measurement service 424 can determine the positions of the component based on each component's distance from the top of the first object. As another example, the measurement service 424 can use the sizing metadata to determine the positions of the components. The measurement service 424 can use the least squares solution from step 709 to calculate the positions of the components on the first object.

At step 721, the image and the location of camera 412 when the image was captured can be stored in the data store 430. The video service 418 can store the image and the location as photo data 433. The sizing metadata, the measurement of the first object, and any sensors measurements from the sensor 415 can also be stored in the data store 430. The measurement service 424 can store the sizing metadata, including the least squares solution calculated at step 709, as sizing metadata 436. The measurement service 424 can also store the measurement of the first object, the sensor measurements, and the positions of the components at measurement data 439.

At step 724, the map service 425 can generate a map associated with the first object. The map service 425 can receive data related to multiple objects, including the first object. For example, the map service 425 can receive the measurements and locations associated with multiple objects. The map service 425 can generate a specific area with multiple flags, each flag representing a location of an object with an associated measurement. The map service 425 can store the map as map data 440.

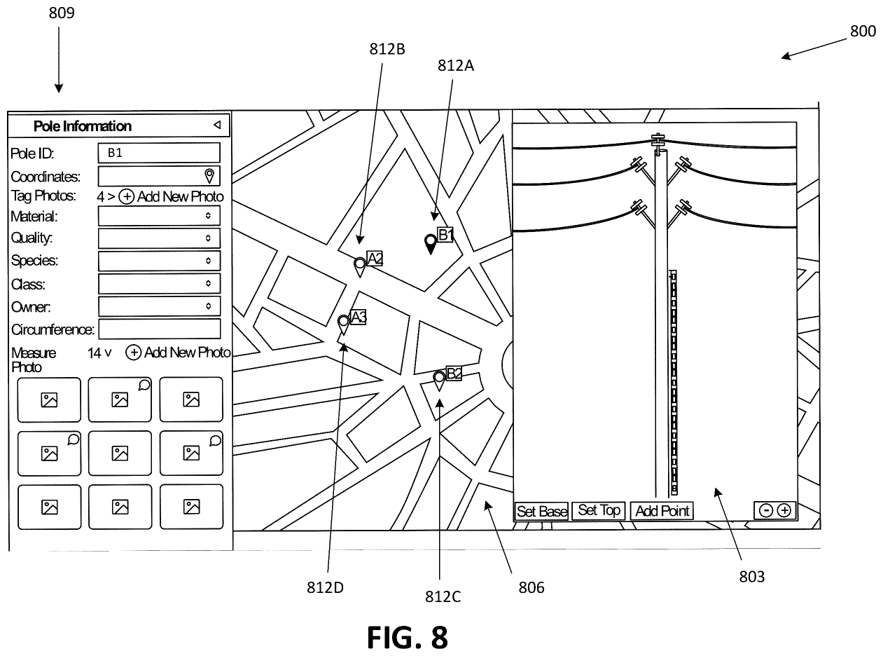

Referring now to FIG. 8, the map 800 shows an exemplary map that can be generated by process 700 at step 724. The map 800 can include image 803, map portion 806, and information 809. The map portion 806 can include flags 812A, 812B, 812C, and 812D. The image 803 can be the image captured from by the camera 412 of the first object. The information 809 can include data related to the first object. As an example, if the first object is a utility pole, the information 809 can list data including, but not limited to, the pole ID, the coordinates of the pole (e.g., coordinates), the material, quality, species, and class of the pole, the owner of the pole, and the circumference of the pole. The information 809 can also include additional images of the first object. The map portion 806 can include flags 812A, 812B, 812C, and 812D. Flags 812A, 812B, 812C, and 812D can indicate the location of the multiple objects on the map portion 806. For example, flag 812A can indicate the location of the first object, shown in the image 803 and associated with the information 809, on the map portion 806.

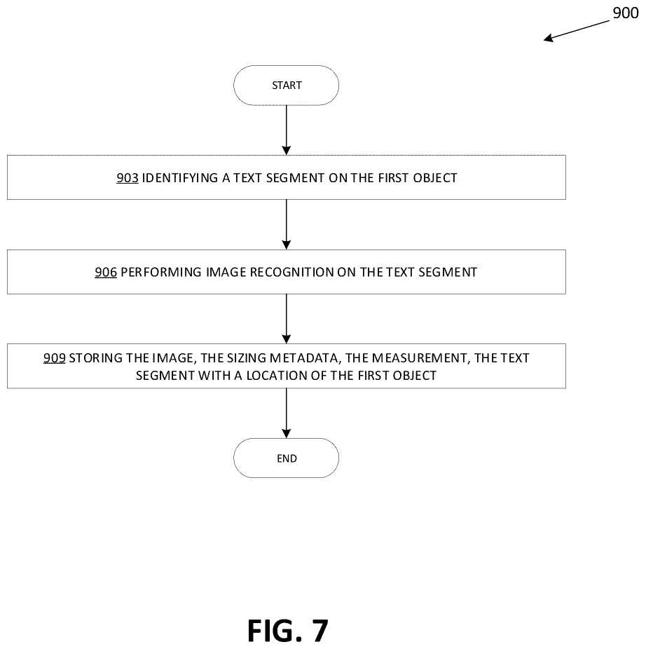

Referring now to FIG. 9, process 900 shows an exemplary process for identifying text segments on an object and performing image recognition on the text according to various embodiments of the present disclosure. At step 903, the text service 426 can identify a text segment on the first object in the image or video feed. For example, if the first object is a utility pole, the text segment can be tags or labels on the pole indicating information about the utility pole (e.g., pole identifier, material, owner, circumference, warnings). In another example, if the first object is a structure, the text segment can be signs or addresses associated with the structure. The text service 426 can identify the text by performing text or image recognition techniques.

At step 906, the text service 426 can determine the contents of the text segment. The text service 426 can determine the contents by using text or image recognition techniques, including but not limited to, optical character recognition. At step 909, the text service 426 can store the text segment in the data store 430 as text data 442. The stored text can be associated with other data in the data store 430, including but not limited to, the image of the first object, the measurement of the first object, and the location of the first object.

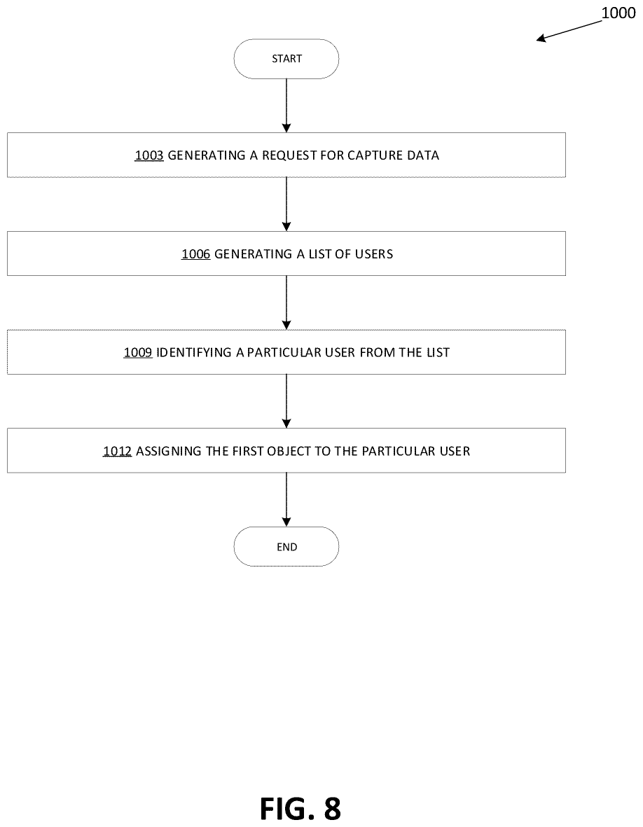

Referring now to FIG. 10, process 1000 shows an exemplary process for identifying and assigning a user to capture a video feed of multiple objects. At step 1003. the user service 427 can generate a request for capture data. The request can be a request for a user to capture a video feed in a specific area including one or more objects. For example, the request can specify an area including one or more objects. The request can also specify which objects in the area that should be included in the capture data. The request can include other information such as time to complete the request. As an example, the request can specify that a user capture a video feed of the first object.

At step 1006, the user service 427 can generate a list of users. The users can be accounts associated with any of the multiple computing devices 406. The list of users can list users eligible to complete the request generated at step 1003. The list of users can list users available to complete the request generated at step 1003. At step 1009, the user service 1009 can identify a particular user from the list generated at step 1006. The particular user can be a user who accepted the request generated at step 1003. The particular user can be user who was selected by the user service 427 to complete the request generated at step 1003. At step 1012, the user service 427 can assign the particular user to the request.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

1. A non-transitory computer-readable medium embodying a program that, when executed by at least one computing device, causes the at least one computing device to:
capture a video feed from a camera comprising a plurality of frames;
render the video feed from the camera on a display in real time;
analyze the video feed to generate a three-dimensional model comprising a physical object depicted in the video feed;
identify a plane in alignment with the physical object in the three-dimensional model, wherein the plane extends indefinitely along one or more axes in the three-dimensional model;
place a virtual object onto the plane in alignment with the physical object in the three-dimensional model, the virtual object comprising a particular pixel design, wherein the particular pixel design comprises a plurality of fixed points and each fixed point is separated by a respective defined plurality of pixels;
render the virtual object in the video feed on the display in real time;
capture an image comprising the physical object and the virtual object rendered in the video feed;
determine sizing metadata based on the virtual object and the physical object in the image by applying a linear algebra algorithm to the virtual object, wherein the sizing metadata comprises associating each of the respective defined plurality of pixels to a respective measurement;
calculate a measurement of the physical object based on the sizing metadata;
identify a plurality of components located along the physical object; and
determine a position for each of the plurality of components based on the sizing metadata.

2. The non-transitory computer-readable medium of claim 1, wherein the physical object is oriented along a first axis and the program further causes the at least one computing device to:
determine an end of the physical object along the first axis; and
identify the plane associated to the physical object in the video feed based on the end of the physical object.

3. The non-transitory computer-readable medium of claim 2, wherein the plane is perpendicular to the first axis.

4. The non-transitory computer-readable medium of claim 1, wherein the program further causes the at least one computing device to maintain a position of the virtual object on the plane over time.

5. The non-transitory computer-readable medium of claim 1, wherein the program further causes the at least one computing device to render the virtual object parallel to the physical object and with the physical object touching the virtual object.

6. The non-transitory computer-readable medium of claim 1, wherein the program further causes the at least one computing device to:
determine a plurality of component positions along the physical object individually corresponding to a respective one of the plurality of components based on the measurement of the physical object.

7. The non-transitory computer-readable medium of claim 1, wherein the measurement comprises a height of the physical object.

8. A system comprising:
a data store; and
at least one computing device in communication with the data store, the at least one computing device configured to:
capture a video feed from a camera comprising a plurality of frames;
render the video feed from the camera on a display in real time;
analyze the video feed to generate a three-dimensional model comprising a physical object depicted in the video feed;
identify a plane in alignment with the physical object in the three-dimensional model, wherein the plane extends indefinitely along one or more axes in the three-dimensional model;
place a virtual object onto the plane in alignment with the physical object in the three-dimensional model, the virtual object comprising a particular pixel design, wherein the particular pixel design comprises a plurality of fixed points and each fixed point is separated by a respective defined plurality of pixels;
render the virtual object in the video feed on the display in real time;
capture an image comprising the physical object and the virtual object rendered in the video feed;
determine sizing metadata based on the virtual object and the physical object in the image by applying a linear algebra algorithm to the virtual object, wherein the sizing metadata comprises associating each of the respective defined plurality of pixels to a respective measurement;
calculate a measurement of the physical object based on the sizing metadata;
identify a plurality of components located along the physical object; and
determine a position for each of the plurality of components based on the sizing metadata.

9. The system of claim 8, wherein the at least one computing device is further configured to:
identify at least one text segment on the physical object in the image;
determine the at least one text segment by performing image recognition on the at least one text segment in the image; and
store the image, the sizing metadata, the measurement, and the at least one text segment in the data store associated with a positioning location of the physical object.

10. The system of claim 8, wherein the at least one computing device is further configured to:
generate a request to capture data for a plurality of objects, wherein the plurality of objects comprises the physical object;
identify a user account associated with a mobile computing device of the at least one computing device; and
assign the physical object to the user account, wherein the mobile computing device comprises the camera.

11. The system of claim 8, wherein the at least one computing device is further configured to store the image in the data store associated with a location of the camera when the image was captured.

12. The system of claim 8, further comprising a LIDAR sensor, wherein the at least one computing device is further configured to:
determine a distance of the physical object from the camera based on a LIDAR measurement from the LIDAR sensor; and
determine the sizing metadata further based on the distance.

13. The system of claim 12, wherein the image is further stored with at least one additional sensor measurement and the at least one computing device is further configured to determine an orientation of the camera based on the at least one additional sensor measurement.

14. A method comprising:
capturing, via at least one computing device, a video feed from a camera comprising a plurality of frames;
rendering, via the at least one computing device, the video feed from the camera on a display in real time;
analyzing, via the at least one computing device, the video feed to generate a three-dimensional model comprising a physical object depicted in the video feed;
identifying, via the at least one computing device, a plane in alignment with to the physical object in the three-dimensional model, wherein the plane extends indefinitely along one or more axes in the three-dimensional model;
placing, via the at least one computing device, a virtual object onto the plane in alignment with the physical object in the three-dimensional model, the virtual object comprising a particular pixel design, wherein the particular pixel design comprises a plurality of fixed points and each fixed point is separated by a respective defined plurality of pixels;
rendering, via the at least one computing device, the virtual object in the video feed on the display in real time;
capturing, via the at least one computing device, an image comprising the physical object and the virtual object rendered in the video feed;
determining, via the at least one computing device, sizing metadata based on the virtual object and the physical object in the image by applying a linear algebra algorithm to the virtual object, wherein the sizing metadata comprises associating each of the respective defined plurality of pixels to a respective measurement;
calculating, via the at least one computing device, a measurement of the physical object based on the sizing metadata;
identifying, via the at least one computing device, a plurality of components located along the physical object; and
determining, via the at least one computing device, a position for each of the plurality of components based on the sizing metadata.

15. (canceled)

16. (canceled)

17. The method of claim 14, wherein calculating the measurement of the physical object based on the sizing metadata comprises applying, via the at least one computing device, the linear algebra algorithm to the image using the sizing metadata.

18. The method of claim 14, further comprising:
determining, via the at least one computing device, a first location of the camera; and
calculating, via the at least one computing device, a second location of the physical object based on the first location and the sizing metadata.

19. The method of claim 14, further comprising:
capturing, via the at least one computing device, a plurality of initial images associated with the physical object from a plurality of perspectives; and
calibrating, via the at least one computing device, the at least one computing device for determining the sizing metadata.

20. The method of claim 14, further comprising:
identifying, via the at least one computing device, a plurality of measurement data sets associated with a plurality of objects at a plurality of locations, wherein one of the plurality of measurement data sets comprises the measurement of the physical object; and
generating, via the at least one computing device, a map of an area comprising the plurality of objects individually located at a corresponding one of the plurality of locations.

21. The non-transitory computer-readable medium of claim 1, wherein determining the sizing metadata based on the virtual object and the image comprises:
determining a respective measurement for each of the respective defined plurality of pixels; and
calculating the sizing metadata based on each of the respective measurements and each fixed point.

22. The non-transitory computer-readable medium of claim 2, wherein the physical object is orientated along a second axis and a third axis, and the virtual object is placed in alignment with the first axis, the second axis, and the third axis.
